(19) United States
(12) Patent Application Publication
(10) Pub. No.: US 2008/0189595 A1
(43) Pub. Date: Aug. 7, 2008

(54) CHAINING CONFIGURATION SETS IN A CONTENT MANAGEMENT SYSTEM

(76) Inventor: John Edward Petri, Lewiston, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/671,836

(22) Filed: Feb. 6, 2007

(51) Int. Cl. G06F 17/00

(52) U.S. Cl. 715/210; 715/209

(57) ABSTRACT

Method and apparatus for chaining configuration sets in a content management system (CMS). A CMS groups configuration rules from multiple configuration sets and for rule inheritance between configuration sets. The configuration sets provide a set of processing rules or artifacts used with content managed by the CMS, (e.g., a collection of XML documents).

### BACKGROUND OF THE INVENTION

1. Field of the Invention

Embodiments of the invention are generally related to managing a collection of data objects in a content management system. More specifically, embodiments of the invention are related to a method and system for managing an XML document stored in a content management system using configuration set chaining policies.

2. Description of the Related Art

Content management systems (CMS) allow multiple users to share information. Generally, a CMS allows users to create, modify, archive, search, and remove data objects from an organized repository. The data objects managed by CMS may include documents, spreadsheets, database records, digital images and digital video sequences, to name but a few. A CMS typically includes tools for document publishing, format management, revision and/or access control, along with tools for document indexing, searching, and retrieval.

A CMS may provide the users with a variety of advantages, for example:
structured authoring—the ability to incorporate metadata that is normally lost in conventional formats
repurposing of data—the ability to share fragments of data or to transform the data into different formats
publishing—the ability to have “single source publishing” using XMLstylesheets (e.g. XSLT) that separate content from presentation
interoperability—the ability to utilize XML data across different systems or applications
intelligent storage—the ability to synchronize XML content with attributes in the CMS
   Because of these, and other advantages, XML is growing in popularity as the preferred format for authoring and publishing (e.g. for Web page authoring/publishing).

To provide these advantages, a CMS may be configured with rules for processing documents whenever a document flows into or out of the repository. For example, rules may be defined for XML documents, such as a rule for bursting an XML document into a collection of document fragments or a rule for synchronizing content from a document with attributes managed by the CMS. Often these rules are included with a logical collection of other XML configuration artifacts such as document type definitions (DTDs), schemas, style sheets, etc. This collection of XML configuration artifacts is sometimes referred to as a configuration set. In order to be processed correctly, XML documents must be associated with a proper configuration set; for example, a configuration set that matches the grammar or document type of the document being processed. Some CMS systems select a collection of XML configuration artifacts based on the content of the XML document and other repository attributes. Such systems however, typically rely on a static directory structure and a limited collection of attributes to manage the XML configuration artifacts for a given document. Problems may arise with this approach when the CMS contains multiple configuration sets that are very similar. A CMS typically tries to automatically determine the correct configuration set to associate with an XML document in the repository; however, if all of the factors that determine this association, such as DTD name, schema, or other repository attributes, are identical for more than one configuration set, then the CMS may not be able to determine which configuration set to use. This could be the case when two or more XML documents are very similar but have subtle differences; for example, they use different style sheets. Since a small difference such as a different style sheet would not likely affect the CMS′ matching algorithm, the system may be unable to determine which configuration set to use or may choose an incorrect one.

Further, document types using specialized or industry specific grammars often include references to other documents. For example, documents may have a parent child relationship. Alternatively, a compound document backbone may be used to support any number of modules. A good example of this scenario occurs in the field of regulatory compliance in the pharmaceutical industry. The International Conference on Harmonization of Technical Requirements (ICH) has published a standard set of XML files for governing electronic drug submissions to the FDA (known as eCTD—electronic common technical document). The eCTD is basically an XML backbone that references additional supporting documents. Some of its supporting documents are also XML documents governed by their own grammar. However, when the user creates a new eCTD document, the supporting XML documents should be associated with their own sets of XML related artifacts (DTDs, schemas, etc) and these associations should be transparent to the user. Current approaches to managing documents with these complex compound document structures proceed by associating each document (eCTD and supporting) with at most a single configuration set.

Similarly, situations often arise where multiple versions of a DTD or schema need to be effective at the same time for a particular document type. However, the approach of statically linking a document type to a particular set of related files does not provide the ability to associate different versions of a DTD or schema (or any XML configuration artifact for that matter) to documents of a particular type. For example, assume that a regulatory organization has published version 3.0 and version 4.0 of a document specification governing new drug applications, the organization may agree to accept documents based on version 3.0 until some specified date, at which point relevant parties must submit documents based on version 4.0. A company may have several in-progress documents that have been developed according to version 3.0 that will be submitted before the use of version 4.0 is required, but would like to create all new documents using the 4.0 schema. In such a situation, both document versions may use many of the same related artifacts (DTDs, schemas, etc), however a separate configuration set would need to be created for each version. This can lead to a tedious and nearly duplicative effort by a system administrator when setting up the new, slightly modified, configuration set. Similarly, when multiple configuration sets exist which have only minor differences between them, a change which is applicable to all such configuration sets may result in the system administrator expending a considerable amount of effort individually updating each configuration set.

Accordingly, there remains a need for techniques for managing configuration sets (e.g., a collection of XML schemas, DTDs, style sheets, transforms, rules, etc.) for documents stored in a content management system which reduces redundant configuration effort and provides for the production of sophisticated document management rules.

### SUMMARY OF THE INVENTION

Embodiments of the invention include a method of managing a document in a content management system (CMS). This method generally includes receiving a request to access a document of a specified document type and includes identifying a first and second configuration set associated with the document specified in the request. The first configuration set specifies at least a first processing rule for processing the document, and the second configuration set specifies at least a second processing rule for processing the document. This method also includes identifying a chaining policy associated with the document specified in the request. The chaining policy may specify a chaining rule for applying the first processing rule and the second processing rule to the document. The method also includes binding the document to the chaining policy such that the first processing rule and the second processing rule are applied to the document as specified by the chaining policy.

Another embodiment includes a computer-readable storage medium containing a program which, when executed, performs an operation for managing a document in a content management system (CMS). The operation generally includes receiving a request to access a document of a specified document type and includes identifying a first and second configuration set associated with the document specified in the request. The first configuration set specifies at least a first processing rule for processing the document, and the second configuration set specifies at least a second processing rule for processing the document. The operation further includes identifying a chaining policy associated with the document specified in the request, where the chaining policy specifies a chaining rule for applying the first processing rule and the second processing rule to the document and binding the document to the chaining policy, such that the first processing rule and the second processing rule are applied to the document as specified by the chaining policy.

Embodiments of the invention also include a system having a processor and a memory containing a content management system (CMS) program. When executed by the processor, the CMS program is generally configured to receive a request to access a document of a specified document type and to identify a first and second configuration set associated with the document specified in the request. The first configuration set specifies at least a first processing rule for processing the document, and the second configuration set specifies at least a second processing rule for processing the document. The program may also be configured to identify a chaining policy associated with the document specified in the request, where the chaining policy specifies a chaining rule for applying the first processing rule and the second processing rule to the document and configured to bind the document to the chaining policy such that the first processing rule and the second processing rule are applied to the document as specified by the chaining policy.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a computing environment and content management system (CMS), according to one embodiment of the invention.

FIG. 2 is a conceptual illustration of a client application accessing documents managed by a CMS, according to one embodiment of the invention.

FIG. 3A illustrates an example XML compound document that includes a chain of configuration set bindings for a parent document, as well as bindings for multiple child documents, according to one embodiment of the invention.

FIG. 3B illustrates the example XML compound document with its parent document, child documents, and associated bindings as they are viewed by a client application, according to one embodiment of the invention.

FIG. 4A illustrates a “grouping” mode linking scheme, according to one embodiment of the invention.

FIG. 4B illustrates an “inherit” mode linking scheme, according to one embodiment of the invention.

FIG. 5 illustrates a pair of potential chaining policies for an exemplary document type which utilize separate first configuration sets and a common second configuration set, according to one embodiment of the invention.

FIG. 6 illustrates a method for creating a new chaining policy to be used by the content management system to manage a document or document type, according to one embodiment of the invention.

FIG. 7 illustrates a method for requesting a document managed by a CMS which has a related chaining policy, according to one embodiment of the invention.

### DETAILED DESCRIPTION OF THE PREFERRED EMBODIMENTS

Embodiments of the invention provide techniques for a CMS to join configuration rules from multiple configuration sets and for rule inheritance between configuration sets. The configuration sets provide a set of processing rules or artifacts used with content managed by the CMS, (e.g., a collection of XML documents). For example, a configuration set may provide a logical collection of other XML configuration artifacts such as document type definitions (DTDs), schemas, style sheets, etc used with an XML document.

A CMS administrator may configure relationships between different XML configuration sets so that they can be chained together. In one embodiment, the administrator designates a top level XML configuration set which is associated with others via specified relationships to one or more “base” XML configuration sets (in addition, a base XML configuration set can further be chained with other base XML configuration sets and so on). When creating a new XML document, a user may be prompted to select which top level XML configuration set to bind to the new XML document. Typically, configuration set chaining is transparent to the end user, as the end user checks in/checks out content from the CMS and is provided with the appropriate configuration set for a given XML document.

Additionally, as part of configuring the base and subordinate XML configuration set relationships, the CMS administrator may specify policies to determine how each chained relationship should interact with others in a given chain. For example, one relationship may be configured to allow inheritance (rules from the base configuration set are carried forward to subordinate configuration sets, while subordinate configuration sets can override rules defined in the base set or add new ones). This technique provides a good mechanism for configuration reuse and extension. As an example of inheritance, assume that a base configuration set A defines rules R1, R2, and R3. In addition, configuration set B inherits from configuration set A and redefines rule R3. When the CMS application processes XML data that is bound to this XML configuration set chain, it will evaluate rules R1 and R2 from the base configuration set A, and rule R3 from the sub configuration set B.

Another example of a type of relationship involves joining rules from the base XML configuration set to subordinate XML configuration sets so that all defined rules in all of the configuration sets get processed in order. As an example of joining, assume that a base configuration set A defines rules R1, R2, and R3. In addition, configuration set B is joined to configuration set A and also defines rule R4. When the CMS application processes XML data that is bound to this XML configuration set chain, it will evaluate rule R4 from configuration set B and R1, R2, and R3 from configuration set A, in that order. Thus, when a user accesses a document associated with a chained configuration set, the CMS application inspects the configured policies for a given chain of XML configuration sets and then evaluates the XML data accordingly.

The rules specified in a configuration set (or chained configuration set) can specify any form of processing activity that should be carried out whenever the document is checked in or out from the CMS. For example, the rule may specify to store portions of XML (based on the presence of particular XML element or attribute) as a separate XML document. This process is commonly referred to as “bursting” or “chunking.” In such a case, each burst fragment is stored by the CMS separately and reassembled whenever the document is checked out. Compound documents or documents having a “parent/child,” or “backbone/module” structure may be stored as multiple fragments. For example, a document revision number stored as an XML element within the document may be synchronized with a document revision number stored by the CMS as a database value, whenever the document is checked in (or out) by a user.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Further, embodiments of the invention are described herein adapted for use with the widely used XML markup language. Accordingly, references to data objects, documents, and XML documents generally refers to data marked up using a well-formed collection of XML tags, elements and/or attributes. As is known, an XML document may be used to describe virtually any type of data. For example, XML grammars have been used to describe word processing documents, spreadsheets, database records, digital images and digital video, to name but a few. Further, specialized grammars are frequently specified by a domain specific XML schema (e.g., the eCTD specification). A given XML document may also be associated with additional artifacts such as a document type definition (DTD), XSLT transforms XSL style sheets, and other associated files, tools and utilities. However, the invention is not limited to the XML markup language, XML schemas, and the use of XML documents; rather, embodiments of the invention may be adapted to other markup languages or other data object formats or data representations, whether now known or later developed

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM or DVD-ROM disks readable by a CD-ROM or a DVD-ROM drive) on which information is permanently stored; and (ii) writable storage media (e.g., floppy disks within a diskette drive or a hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

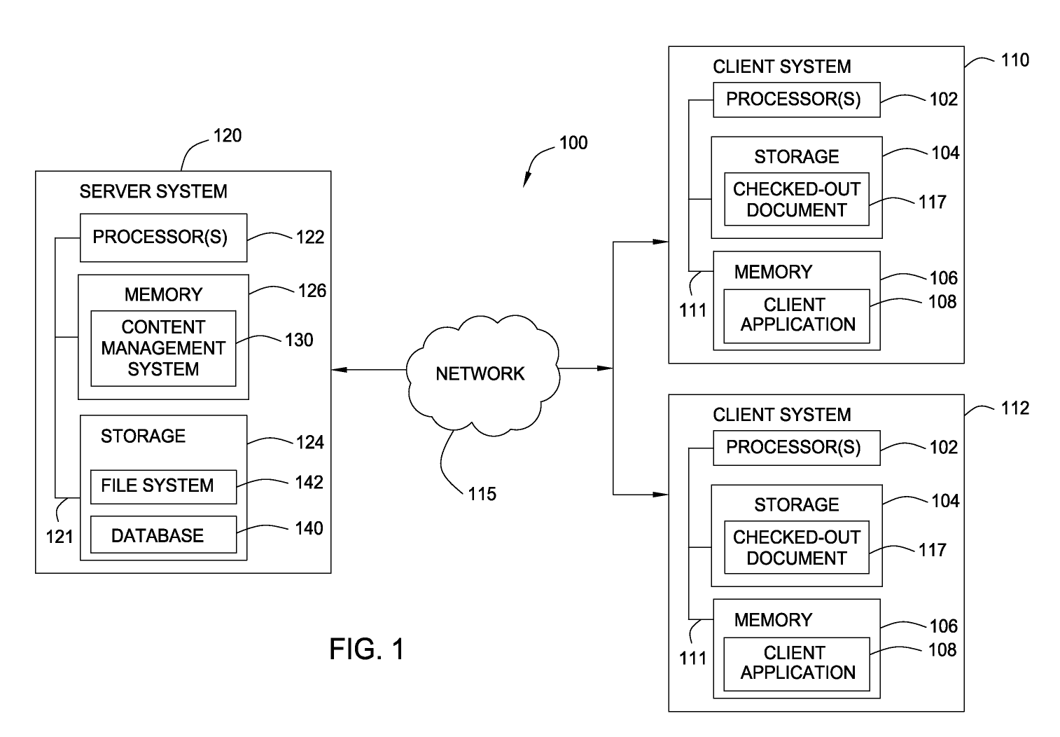

FIG. 1 is a block diagram that illustrates a client/server view of a computing environment 100, according to one embodiment of the invention. As shown, computing environment 100 includes two client computer systems 110 and 112 communicating with a server system 120 over a network 115. The computer systems 110, 112, and 120 illustrated in environment 100 are included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustration of computer systems 110, 112, and 120 are simplified to highlight aspects of the present invention and that computing systems and networks typically include a variety of additional elements not shown in FIG. 1.

As shown, client computer systems 110 and 112 each include a CPU 102, storage 104, and memory 106 connected by a bus 111. CPU 102 is a programmable logic device that performs all the instructions, logic and mathematical processing performed in executing user applications (e.g., a client application 108). Storage 104 stores application programs and data for use by client computer systems 110 and 112. Typical storage devices 104 include hard-disk drives, flash memory devices, optical media and the like. Additionally, the processing activity and access to hardware resources made by client application 108 may be coordinated by an operating system (not shown). Well known examples of operating systems include the Windows® operating system, distributions of the Linux® operating system, and IBM's OS/2@ operating system, among others. (Linux is a trademark of Linus Torvalds in the US, other countries, or both). Network 115 represents any kind of data communications network, including both wired and wireless networks. Accordingly, network 115 is representative of both local and wide area networks, including the Internet.

Illustratively, memory 106 of client computer systems 110 and 112 includes a client application 108. In one embodiment, client application 108 is a software application that allows users to access documents stored by a content management system (CMS) 130. Thus, client application 108 may be configured to allow users to create, edit, and save a documents, e.g., word-processing documents, spreadsheets, database records, digital images or video data objects, to name but a few (collectively referred to as a “documents”) from CMS 130. In one embodiment, client application 108 may be configured to receive a document 115 from CMS 130 and store it in storage 104 while it is being accessed by client application 108. In a particular embodiment, client application 108 is a web-browser.

Documents accessed from CMS 130 may be marked up with XML tags describing the substantive data within the document, relative to an associated XML schema. Additionally, in one embodiment, documents in CMS 130 may be bound to a chaining policy which may identify all configuration sets used in managing the information stored in the document. As stated, a configuration set may specify a collection of related artifacts such as DTDs, schemas, stylesheets, etc., that should be used to manage the XML document. When a new document is created (e.g., a new root or backbone for an eCTD) CMS 130 may prompt the user to specify attributes for the document. The CMS 130 may then use the attributes to filter a collection of potential chaining policies and prompt the user to select a chaining policy to bind with the new document. The CMS 130 then may store the binding between the document and the chaining policy as a repository relation. Additionally, for a compound document such as the eCTD, CMS 130 may create a collection of child documents and bind them to the appropriate chaining policies, prompting the user to specify attribute values as necessary. Thereafter, anytime the XML document (or any of its related child documents) is accessed from CMS 130, the repository relation specifies which chaining policy (and associated configuration sets and their artifacts) should be used to manage the XML document.

The CMS 130 may be further configured to provide lifecycle management for a given chaining policy and its associated configuration sets. For example, versions of documents referenced by a configuration set may change over time, and the configuration set and its associated chaining policies may be configured to always refer to the current version of a given element of the chaining policy or configuration set (e.g., the most current version of a style sheet, DTD or schema). Alternatively, the configuration set may be configured to always refer to a specific version of a given element. This may be useful when different available versions of a document referenced by the configuration set are incompatible with one another.

Server system 120 also includes a CPU 122, CMS storage repository 124, and a memory 126 connected by a bus 121. CMS repository 124 may include a database 140 and file system 142. File system 142 typically provides access to a directory structure contained on a disk drive or network file system and may be used to store files (e.g., documents, chaining policies, and configuration sets managed by CMS 130). Database 140 may contain additional information and metadata related to documents stored in file system 142. Memory 126 of server system 120 includes CMS 130. CMS 130 provides an application program configured for creating, modifying, archiving, and removing content managed by CMS 130. Thus, CMS 130 may include tools used for publishing, format management, revision and/or access control, content indexing, and facilities for performing searches and other operations related to documents managed by CMS 130.

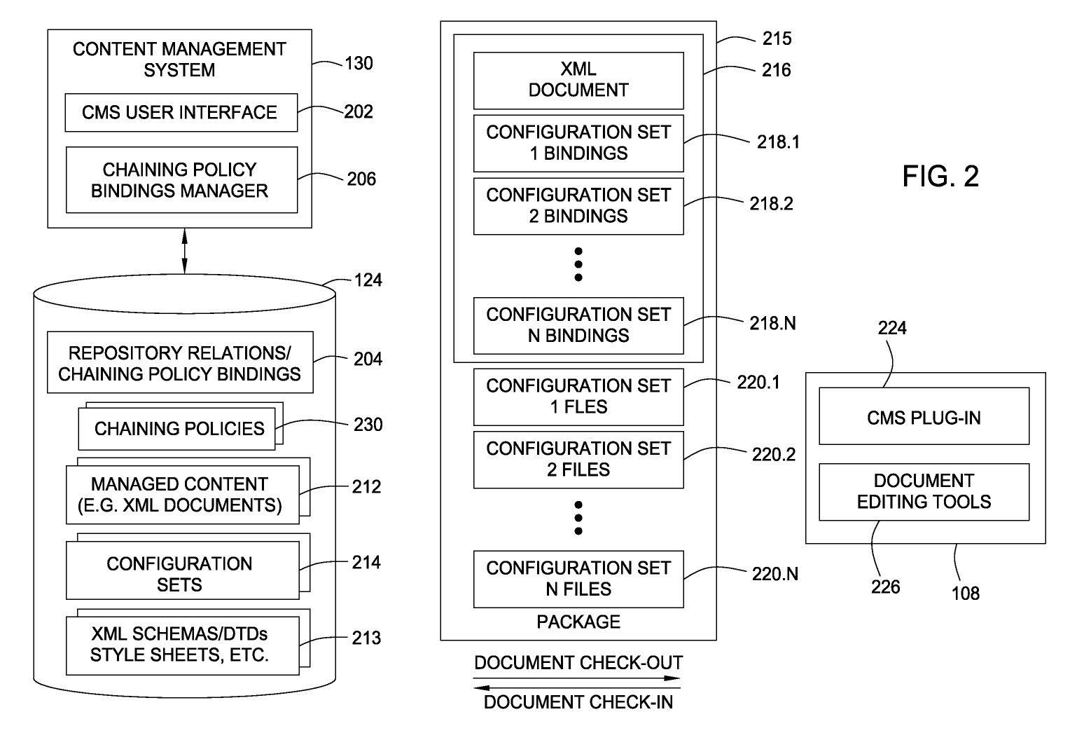

FIG. 2 is a conceptual illustration of client application 108 accessing documents managed by CMS 130, according to one embodiment of the invention. As shown, CMS 130 includes a CMS user interface 202 and a chaining policy bindings manager 206. Those skilled in the art will recognize that the CMS 130 illustrated in FIG. 2 is simplified to highlight aspects of the present invention and that CMS systems typically include a variety of additional elements not shown in FIG. 2.

Generally, user interface 202 provides an interface to the functionality of CMS 130 and managed content 212 stored by database 140 and file system 142. Thus, user interface 202 may provide an interface for checking in/out a document from CMS 130, for creating, viewing, and exporting documents from CMS 130 etc. Additionally, user interface 202 may provide mechanisms that allow a user to define a configuration set 214, to define a chaining policy 230, to create a binding 204 between a particular document and chaining policy 230, to edit an existing configuration set 214, and to edit an existing chaining policy 230. Chaining Policy bindings manager 206 represents the components of CMS 130 configured to manage repository relations 204 and chaining policies 230.

In one embodiment, repository relations 204 specify the bindings between managed documents 212 and chaining policies 230. In other words, repository relations 204 specify which bindings are in effect for a given document 212. Each chaining policy 230 may contain links to multiple configuration sets 214, and each configuration set 214 may specify a collection of related files and/or rules to associate with a document bound to that configuration set 214. For example, a configuration set 214 may specify a collection of artifacts used to manage, validate, and/or process a document bound to that configuration set.

An XML schema/DTD generally defines the allowed content and structure of a given type of XML document. More specifically, XML schemas/DTDs provide rules specifying which elements (e.g., the markup tags) and attributes (i.e., values associated with specific tags) are allowed for a particular type of XML document. For example, the eCTD includes a set of XML schemas/DTDS specifying the allowed structure and content for an eCTD backbone document and related child documents. Each child document in the eCTD may itself be governed by its own grammar and schema. Accordingly, in one embodiment, a parent document (e.g., an eCTD backbone) may be bound to a chaining policy 230 (and thereby its configuration sets) for the parent document, as well as bound to chaining policies (and thereby related configuration sets) appropriate for each child document (e.g., each eCTD module). Thus, the parent's chaining policy and the child's chaining policy may reference a common configuration set. In addition to XML schema/DTDs 213, a configuration set 214 may reference other files such as a stylesheets, transforms (e.g., transforms used to generate an HTML or XHTML document from a source XML document) etc.

FIG. 2 also shows document package 215 being checked out/in from the CMS 130. In one embodiment, when a document 216 is checked out from repository 124, CMS 130 may be configured to determine which chaining policy 230 the document 216 is bound to and include the configuration sets 214 identified in that chaining policy with the document package 215 (shown in FIG. 2 as configuration set bindings 218.1, 218.2, . . . 218.N). Additionally, the CMS 130 may be configured to include the configuration set files 220.1, 220.2, . . . 220.N referenced by the configuration set bindings 218.1, 218.2,. . . 218.N with document package 215, and to return it to the requesting user. Configuration set files 220.1, 220.2, . . . 220.N may include the XML schema(s), DTDs, style sheets, transforms, catalogs, etc., which are referenced by the configuration sets 218.1, 218.2, . . . 218.N.

As shown, client application 108 includes a CMS plug-in 224 and document editing tools 226. CMS plug-in 224 allows client application 108 to interact with CMS 130 and CMS user interface 202. For example, plug-in 224 may allow a user interacting with client application 108 to check-in and check-out documents (e.g., document package 215) from CMS 130. Additionally, CMS plug-in 224 may allow users to select a chaining policy 230, thus creating a new chaining policy binding 204, when creating a new document to store in repository 124 (e.g., a new eCTD backbone and associated child documents). Document editing tools 226 provide the substantive features associated with particular client application 108. For example, a word processing application may provide tools for specifying document presentation style and text-content or a web-browser may be used to render, view, and update an XML document 216. Another example of a client application 108 includes a web-browser application. Of course, depending on the function of client application 108, the features provided by viewing/editing tools 226 can vary.

In one embodiment, client application 108 may attempt to access a compound document stored on the CMS 130. A compound document may include a parent document and one or more associated child documents packaged by the CMS 130 into a single document package 215. After being manipulated or viewed, document package 215 may be returned to CMS 130 for check-in.

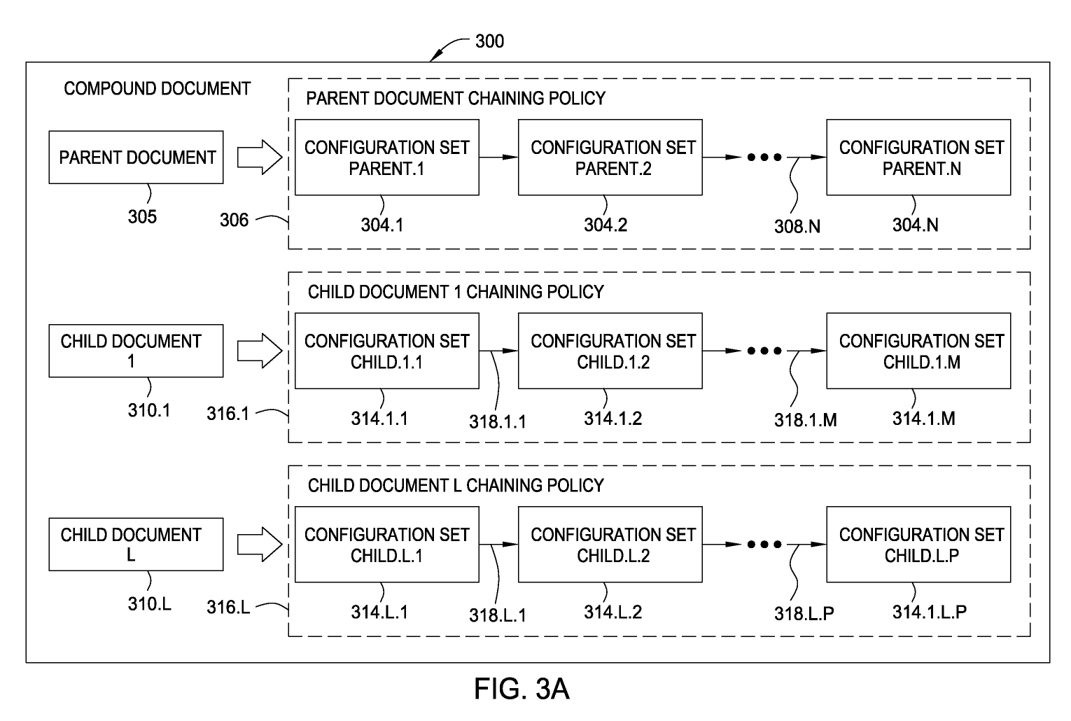

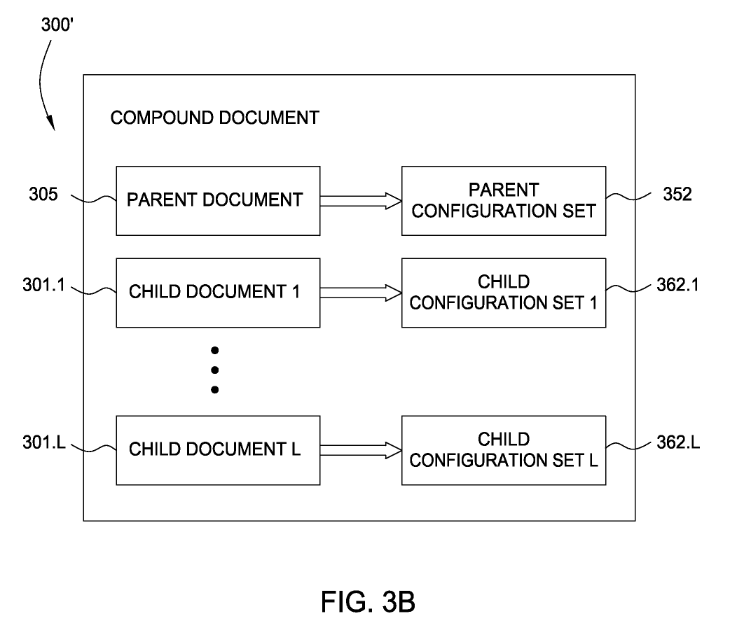

FIGS. 3A and 3B provide a conceptual illustration of a compound document bound to configuration sets, according to one embodiment of the invention. As shown in FIG. 3A, a compound document 300 includes a parent document 305 and child documents 310.1-310.L. Each document 305, 310.1-310.L is bound to an individual chaining policy 306, 316.1-316.L, which may be read by the CMS 130 while building the document package 300. The CMS 130 may include configuration sets identified in each chaining policy 230 in the document package 300. Illustratively, parent document 305 is bound to chaining policy 306 using a configuration set 304.1, which is linked in the chaining policy 306 by a link 308.1 to a second configuration set 304.2. The second configuration set 304.2 may be linked in turn to a third configuration set 304.N. This linking may continue for N links until the Nth link 308.N points to the Nth configuration set. Thus, the chaining policy 306 may identify N configuration sets to associate with the parent document 305. In one embodiment, the order in which the configuration sets 304.1-304.N are linked may determine the order in which they are processed by the CMS 130. Accordingly, operations/processing rules included in configuration set 304.1 may be performed on the parent document 305 prior to executing any operations/processing rules includes in configuration set 304.N.

Similarly, CMS 130 may include configuration sets identified in chaining policies 316.1-316.L, which are associated with child documents 310.1-310.L, in this example. As shown, each child document 310.X (where X represents a particular child document) is bound through a respective chaining policy 316.X to a configuration set 314.X.1, which may be linked in the chaining policy 316.X by a link 318.X.1 to a second configuration set 314.X.2. The second configuration set 314.X.2 may be linked in turn to a third configuration set. This linking may continue for M links until the Mth link 318.X.M points to the Mth configuration set 314.X.M. Thus, the chaining policy 316.X may identify M configuration sets to associate with child document 310.X.

The example document illustrated in FIG. 3A depicts how a single parent document 305 may be bound to multiple child documents 310.1-310.L and thus multiple chaining policies 306, 316.1-316.L, creating compound document 300. By binding compound document 300 to chaining policies 306, 316.1-316.L associated with parent document 305 and child documents 310.1-310.L, the correct set of configuration files (e.g., XML grammar, XML schema, DTD, etc) of documents 305, 310.1-310.L may be readily identified whenever the parent document 305 is accessed by a user.

In one embodiment, as illustrated in FIG. 2 and described above, the CMS 130 may simply include configuration set bindings 218.1-218.N for each configuration set identified in a chaining policy 230 in the document 216. In such a scenario, the configuration set bindings 218.1-218.N may be stored in a particular document, and the files reference by the bindings 220.1-220.N may be stored separately in the document package 215.

In one embodiment, in addition to assembling a document and its configuration sets in the manner described above with reference to FIG. 3A, the CMS 130 may further process the chaining policies 306, 316.1-316.L bound to parent document 305 and its child documents 310.1-310.L. This additional processing may result in the compound document structure 300′ illustrated in FIG. 3B, where each document 305, 310.1-310.L is bound to a single configuration set 352, 362.1-362.L respectively. These single configuration sets may not independently exist in the CMS storage repository 124, but rather are created when the CMS 130 processes the chaining policies 306, 316.1-316.L and their various configuration sets. The CMS 130 may analyze each “link in the chain” of the chaining policy 306, 316.1-316.L to determine how the next configuration set in the chain should relate to configuration sets already processed by the CMS 130. Such relation information may be determined from a linking scheme stored within the chaining policy or stored separately in each configuration set. Alternatively, the CMS 130 may employ a default linking scheme for the document, the document type, or for the content management system 230 as a whole.

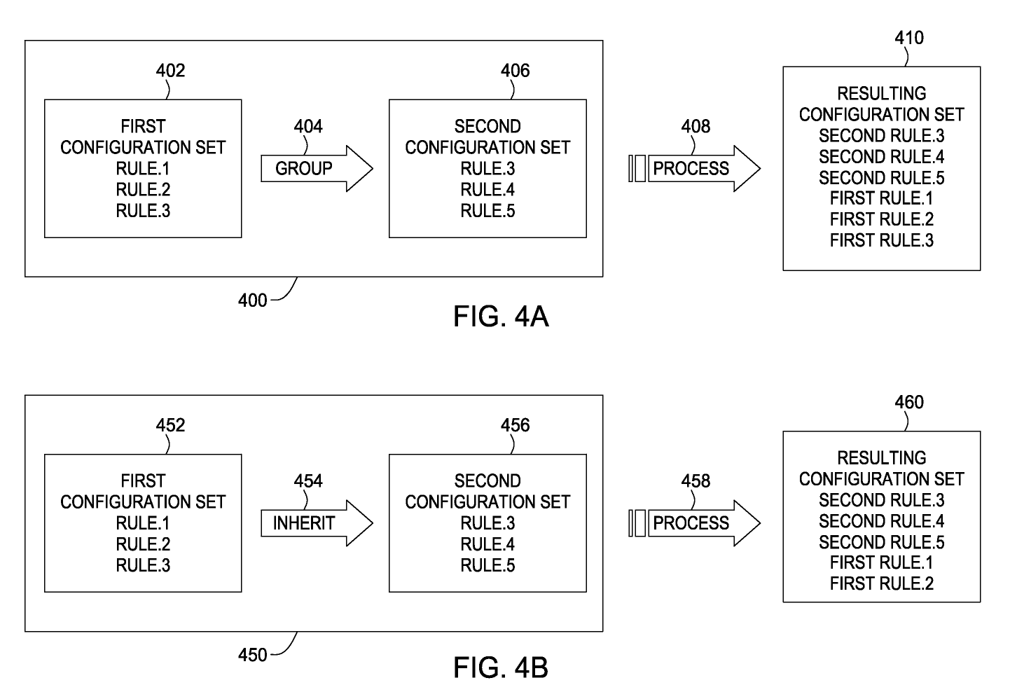

In one embodiment, a “grouping” mode linking scheme may specify that rules (e.g. a content synchronization operation performed when a document is checked out) and XML configuration artifacts (such as DTDs, schemas, style sheets, etc.) referenced in a linked configuration set are to be grouped or added to rules and XML configuration artifacts from configuration sets already processed by the CMS 130. FIG. 4A provides a conceptual illustration of processing a chaining policy 400, according to one embodiment of the invention. As shown, CMS 130 analyzes parent configuration set 402 and determine that the linking scheme 404 linking the first configuration set 402 to second configuration set 406 uses a “grouping” mode, and may therefore add all processing steps of the second configuration set 406 to the processing steps of the first configuration set 402 during processing step 408 to generate configuration set 410. For example, can be seen in FIG. 4A, Rule.3 from configuration set 402 and Rule.3 from configuration set 406 are both included in configuration set 410. Alternatively, the processing steps of the second configuration set 406 may have been added after the processing steps of the first configuration set 402. As previously stated, rules may specify operations to be performed on a document managed by the CMS 130 (e.g. content synchronization), and may be tailored for a given case.

Similarly, in one embodiment, an “inherit” mode linking scheme may specify that rules and XML configuration artifacts referenced in a linked configuration set are to be inherited over rules and XML configuration artifacts contained within configuration sets already processed by the CMS 130. For example, FIG. 4B provides a conceptual illustration of the processing of chaining policy 450. During processing step 458, CMS 130 analyzes a first configuration set 452 and determines that the linking scheme 454 (linking a first configuration set 452 to a second configuration set 456) should use an “inherit” mode, and adds the processing steps of the second configuration set 456 to the processing steps of the first configuration set 452, settling any rule conflicts in favor of the second configuration set 456. As can be see in FIG. 4B, Rule.3 from the first configuration set 452 is replaced with Rule.3 from the second configuration set 456 in the resultant configuration set 460.

In another embodiment, processing of the chain may begin with the last configuration set in the chain and may continue along the chain until the first configuration set is processed. When such a scheme employs an “inherit” mode linking scheme, the last read instance of a rule or XML configuration artifact may govern in conflicts between configuration sets. Therefore, when a rule in a first configuration set conflicts with a rule in a subsequent configuration set, the rule in the first configuration set will control.

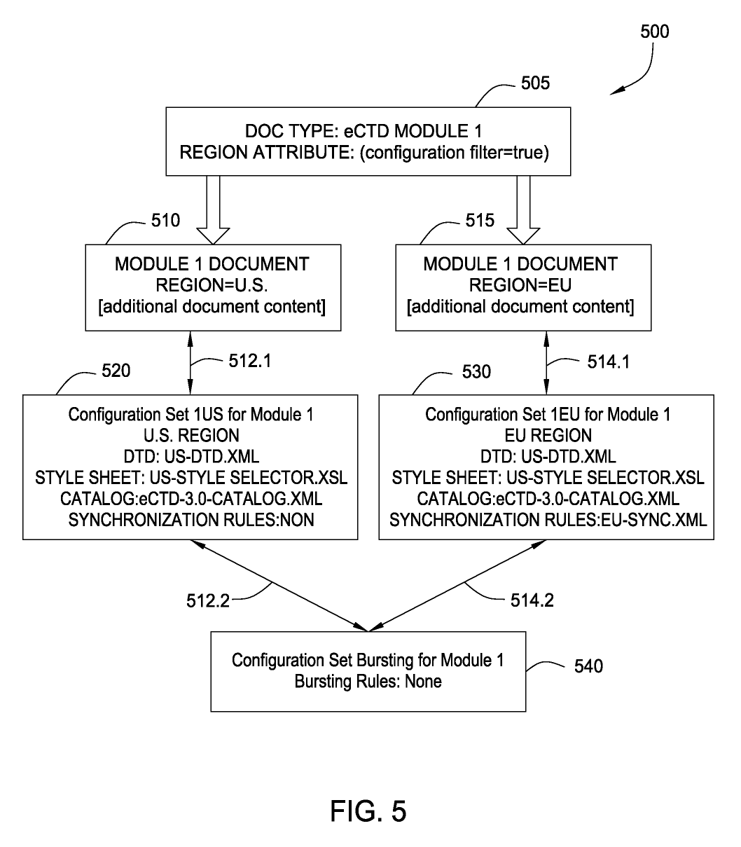

FIG. 5 illustrates chaining policies 500 for an exemplary document type which use different first configuration sets and a common second configuration set, according to one embodiment of the invention. As shown, the “eCTD 1” document type 505 may be associated with different regions, based on a region attribute specified when the document was created. In this example, the region attribute may be used by the CMS 130 to select a chaining policy 230.

Specifically, an “eCTD module 1” document 510 with the region attribute set to “US” and an “eCTD module 1” document 515 with the region attribute set to “EU” are illustrated. Documents 510 and 515 are bound to the appropriate chaining policies and their respective configuration sets 520, 530, 540, based on the region type. Illustratively, document 510 is bound to its first configuration set 520, and a second configuration set 540 according to the chaining policy for the US region (shown using arrows 512.1 and 512.2). And document 515 is bound to its first configuration set 530, and the second configuration set 540 according to the chaining policy for the EU region (shown using arrows 514.1 and 514.2). This example illustrates how two separate, but related, chaining policies may share a common node in their respective “chains” of configuration sets.

Furthermore, configuration sets 520 and 530 may each include references to a set of configuration files that should be used in processing the respective documents 510 and 515. For example, the configuration set 520 references a DTD of “US-DTD.XML” for document 510. Similarly, configuration set 530 references a DTD of “EU-DTD.XML.” for document 515. By managing a collection of artifacts associated with a given document type using a configuration set, changes made to the configuration set are automatically incorporated by documents bound with that configuration set. Furthermore, whenever the common configuration set 540 is modified, both chaining policies identified by arrows 512 and 514 will be updated. Thus, whenever a document is accessed, the CMS may also identify and provide the correct set of related files used to manage the document.

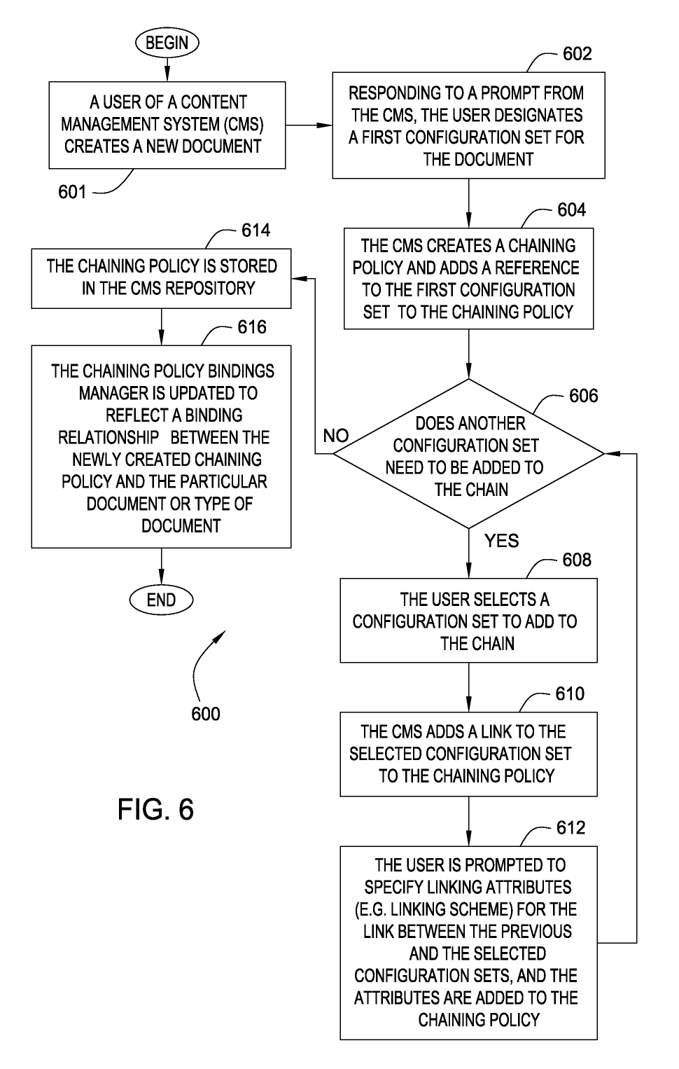

FIG. 6 illustrates a method 600 for creating a new document and chaining policy 230 within a CMS 130, according to one embodiment of the invention. The method 600 begins at step 601, where a user of CMS 130 creates a new document. Typically, the user will interact with the CMS 130 through the client application 108. At this point, the user may be prompted to bind the document to an existing chaining policy or to create a new one. Since the current example is to illustrate the creation of a configuration set, it is assumed that the user does not want to use an existing chaining policy.

At step 602, the system, responding to the creation of a new document, may then prompt the user to specify a first configuration set for use with the document. Once the user selects the first configuration set, at step 604, the CMS 130 creates a new chaining policy and adds a reference to the selected configuration set to the chaining policy.

At step 606, the CMS may prompt the user for another configuration set to use with the first configuration set in processing the document. If the first configuration set contains references to all rules and XML schema necessary to manage the document, the document creation process proceeds to step 614, which is described below. Otherwise, the document creation process proceeds to step 608, where the user selects another configuration set to be used in managing the document.

At step 610, a reference to the selected configuration set is added to the chaining policy. At this point, the user may be prompted, as in step 612, to specify attributes of the link from the previous configuration set to the selected configuration set. Such attributes may include a linking scheme (e.g. “grouping” mode or “inherit” mode), whether to use the newest version of the configuration set or always use a particular version, who to notify if the selected configuration set ever becomes obsolete, and the like. These attributes are added to the link in the chaining policy, and the document creation process returns to step 606.

As stated, at step 606, the user may select an additional configuration set to use in managing the document being created. Once references to all required configuration sets have been added to the chaining policy, the document creation process proceeds to step 614. And at step 614, the chaining policy, (and all references to configuration sets and their related linking attributes necessary to manage the document), is stored in the CMS repository 124. Lastly, at step 616, the chaining policy bindings manager 206 is updated to reflect the new document and its relationship to the newly created chaining policy.

In an alternate embodiment, a first configuration set in a chain may be preconfigured to link to a second configuration set which, as appropriate, may be preconfigured to link to a third configuration set, etc. In this situation, all a user needs to do is to specify the first configuration set to associate with a document, and the CMS 130 would use the preconfigured relations to automatically build the chaining policy. In fact, a separate chaining policy structure may not need to be stored in the CMS repository 124. Rather, the bindings manager 206 would simply indicate the binding between a document and the first configuration set in the chain. The linking information in the configuration set(s) should be sufficient to establish the structure of the chaining policy for the document.

In another alternative, documents of a given type may be associated with a specific configuration set and chaining policy. In such a case, CMS 130 may select the appropriate configuration set based on a selection to create a new document of that given type. In such a case, the new document is created and the chaining policy bindings manager 206 may be updated accordingly. Alternatively, no binding may be stored, and the CMS 130 may analyze the document each time it is accessed to determine the appropriate preexisting chaining policy to use with the document.

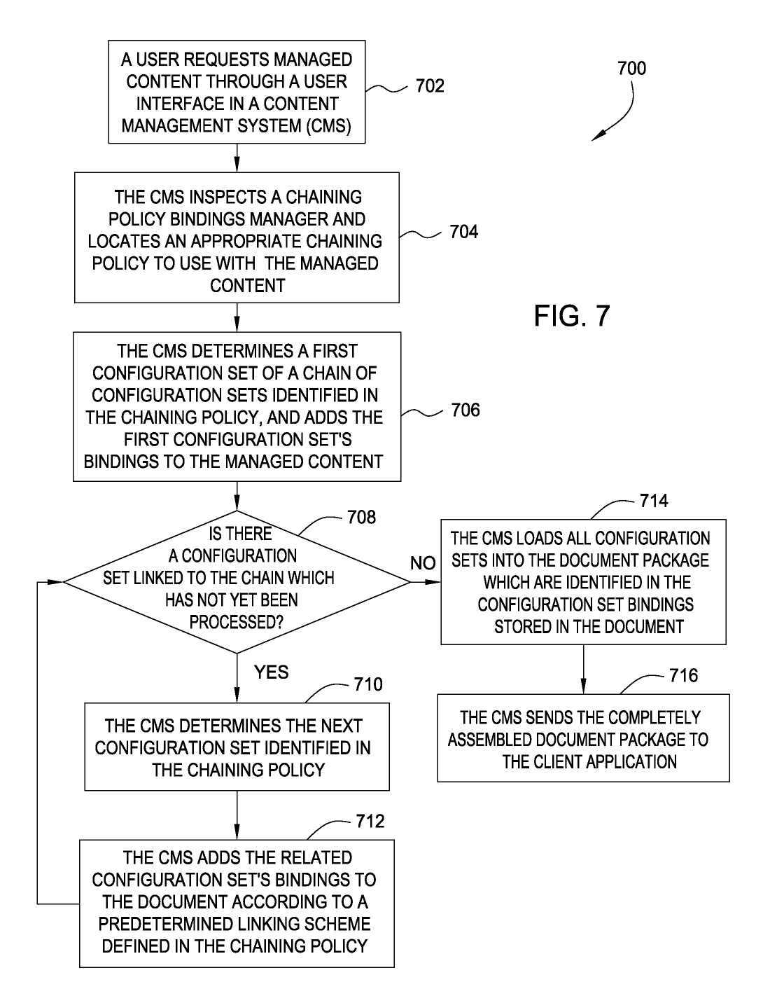

FIG. 7 illustrates a method 700 for requesting a document managed by a CMS 130 which has a related chaining policy, according to one embodiment of the invention. At step 702, a user requests a document from a client application 108 through a CMS user interface 202 in a CMS 130. In response, at step 704, the CMS 130 inspects a chaining policy bindings manager 206 and locates an appropriate chaining policy 230 to use with the document requested in step 702.

At step 706, the CMS 130 determines a first configuration set of a chain of configuration sets identified in the chaining policy 230, and adds the first configuration set's bindings to the document. The CMS 130 then analyzes the chaining policy, at step 708, to determine if there is an additional configuration set linked in the chain of configuration sets which has not been processed by the CMS 130. If there are no further linked configuration sets, the process proceeds to 714, described below. Otherwise, the processing of method 700 proceeds to step 710.

At step 710, the CMS 130 locates the next configuration set “linked” or identified in the chaining policy. In step 712, the bindings in the linked configuration set are subsequently added to the document pursuant to a predetermined linking scheme identified in the chaining policy. For example, the linking scheme may be “grouping” mode, and may specify that the rules in the linked configuration set are to be grouped with previously identified rules in other processed configuration sets, resulting in the addition of all bindings (and therefore rules) in the linked configuration set being added to the document. Alternatively, if the linking scheme for the linked configuration set is “inherit” mode, then new bindings may control when they conflict with existing bindings in the document, and the existing binding may be removed or ignored when the document is processed. In another alternate embodiment, the linking scheme may consist of rules directed towards individual elements of the linked configuration set. Accordingly, some bindings identified in the linked configuration set may be incorporated into the document according to “grouping” mode, where other bindings may be incorporated according to “inherit” mode.

The processing of method 700 may then return to step 708, where the process proceeds as described above if there are additional configuration sets “linked” in the chaining policy which have not yet been processed. Otherwise, the processing of method 700 proceeds to step 714. In step 714, the CMS 130 analyzes the configuration set bindings in the document and loads the files referenced in the bindings into the document package 215. Lastly, in step 716, the CMS 130 sends the assembled package 215 to the requesting client application 108 for further processing and use.

In one alternate embodiment, rather than using a chain structure where one configuration set is linked to at most two other configuration sets, configuration sets may exist in a tree structure or even in a web of linked configuration sets. When such non-linear structures are used to identify the configuration sets of a given document, a hierarchy may be used to ensure that the nodes (configuration sets) of the tree or web are processed in the correct order.

While the foregoing is directed to embodiments of the present invention, other and further embodiments of the invention may be devised without departing from the basic scope thereof, and the scope thereof is determined by the claims that follow.

What is claimed is:

1. A method of managing a document in a content management system (CMS), comprising:
receiving a request to access a document of a specified document type;
identifying a first configuration set associated with the document specified in the request, wherein the first configuration set specifies at least a first processing rule for processing the document;
identifying a second configuration set associated with the document specified in the request, wherein the second configuration set specifies at least a second processing rule for processing the document;
identifying a chaining policy associated with the document specified in the request, wherein the chaining policy specifies a chaining rule for applying the first processing rule and the second processing rule to the document; and
binding the document to the chaining policy, wherein the first processing rule and the second processing rule are applied to the document as specified by the chaining policy.

2. The method of claim 1, wherein the document is an XML document.

3. The method of claim 2, wherein at least one of the first processing or second processing rule is a bursting rule, specifying one or more elements of the XML document to store independently in the CMS from other elements in the XML document.

4. The method of claim 2, wherein at least one of the first processing or second processing rule is a synchronization rule specifying to synchronize an element of content in the document with a corresponding data element in a CMS repository.

5. The method of claim 4, wherein the CMS repository is a database.

6. The method of claim 1, wherein the chaining policy specifies an “inheritance” mode for applying the first processing rule and the second processing rule, wherein the second processing rule inherits an attribute of the first processing rule, and wherein only the second processing rule is applied to the document.

7. The method of claim 1, wherein the chaining policy specifying a “grouping” mode, wherein the grouping mode specifies to apply the first processing rule and the second processing rule, according to a rule processing order included by the chaining policy.

8. The method of claim 1, wherein at least one of the configuration sets further specifies at least one of an XML schema, a document type definition (DTD), an XSL style sheet, an XML catalog, and an XSLT transform to associate with the document.

9. A computer-readable storage medium containing a program which, when executed, performs an operation managing a document in a content management system (CMS), comprising:
receiving a request to access a document of a specified document type;
identifying a first configuration set associated with the document specified in the request, wherein the first configuration set specifies at least a first processing rule for processing the document;
identifying a second configuration set associated with the document specified in the request, wherein the second configuration set specifies at least a second processing rule for processing the document;
identifying a chaining policy associated with the document specified in the request, wherein the chaining policy specifies a chaining rule for applying the first processing rule and the second processing rule to the document; and
binding the document to the chaining policy, wherein the first processing rule and the second processing rule are applied to the document as specified by the chaining policy.

10. The computer-readable storage medium of claim 9, wherein the document is an XML document.

11. The computer-readable storage medium of claim 10, wherein at least one of the first processing rule or the second processing rule is a bursting rule, specifying one or more elements of the XML document to store independently in the CMS from other elements in the XML document.

12. The computer-readable storage medium of claim 10, wherein at least one of the first processing rule or the second processing rule is a synchronization rule specifying to synchronize an element of content in the document with a corresponding data element in a CMS repository.

13. The computer-readable storage medium of claim 12, wherein the CMS repository is a database.

14. The computer-readable storage medium of claim 9, wherein the chaining policy specifies an “inheritance” mode for applying the first processing rule and the second processing rule, wherein the second processing rule inherits an attribute of the first processing rule, and wherein only the second processing rule is applied to the document.

15. The computer-readable storage medium of claim 9, wherein the chaining policy specifying a “grouping” mode, wherein the grouping mode specifies to apply the first processing rule and the second processing rule, according to a rule processing order included by the chaining policy.

16. The computer-readable storage medium of claim 9, wherein at least one of the configuration sets further specifies least one of an XML schema, a document type definition (DTD), an XSL style sheet, an XML catalog, and an XSLT transform to associate with the document.

17. A system, comprising:
a processor; and
a memory containing a content management system (CMS) which, when executed by the processor, is configured to:
receive a request to access a document of a specified document type;
identify a first configuration set associated with the document specified in the request, wherein the first configuration set specifies at least a first processing rule for processing the document;
identify a second configuration set associated with the document specified in the request, wherein the second configuration set specifies at least a second processing rule for processing the document;
identify a chaining policy associated with the document specified in the request, wherein the chaining policy specifies a chaining rule for applying the first processing rule and the second processing rule to the document; and
bind the document to the chaining policy, wherein the first processing rule and the second processing rule are applied to the document as specified by the chaining policy.

18. The system of claim 17, wherein the document is an XML document.

19. The system of claim 18, wherein at least one of the first processing rule or the second processing rule is a bursting rule, specifying one or more elements of the XML document to store independently in the CMS from other elements in the XML document.

20. The system of claim 18, wherein at least one of the first processing rule or second processing rule is a synchronization rule specifying to synchronize an element of content in the document with a corresponding data element in a CMS repository.

21. The system of claim 17, wherein the chaining policy specifies an “inheritance” mode for applying the first processing rule and the second processing rule, wherein the second processing rule inherits an attribute of the first processing rule, and wherein only the second processing rule is applied to the document.

22. The system of claim 17, wherein the chaining policy specifying a “grouping” mode, wherein the grouping mode specifies to apply the first processing rule and the second processing rule, according to a rule processing order included by the chaining policy.

23. The system of claim 17, wherein at least one of the configuration sets further specifies least one of an XML schema, a document type definition (DTD), an XSL style sheet, an XML catalog, and an XSLT transform to associated with the document.
